(19) United States
(12) Patent Application Publication
(10) Pub. No.: US 2004/0199501 A1
(43) Pub. Date: Oct. 7, 2004

(54) Information extracting apparatus

(75) Inventors: Akihiro Okumura, Tokyo (JP); Hiroyuki Ohnuma, Tokyo (JP); Yoshitaka Hamaguchi, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/811,962

(22) Filed: Mar. 30, 2004

(30) Foreign Application Priority Data
Apr. 1, 2003 (JP) 2003-098165

(51) Int. Cl. G06F 7/00

(52) U.S. Cl. 707/3

(57) ABSTRACT

When information is extracted, a start point address designating unit designates a document address as a start point. A maximum link depth designating unit designates a maximum link depth. An extracting unit extracts the information from the target document designated as a start point. If the information cannot be extracted from the target document, the information is extracted in a range of the maximum link depth from a link destination document of the target document on the basis of the document address. An information extracting apparatus which can accurately extract the information even in the case of a document in a hypertext format is obtained.

### BACKGROUND OF THE INVENTION

1. Field of the Invention

The invention relates to a natural language processing system and, more particularly, to an information extracting apparatus for extracting specific information.

2. Related Background Art

Hitherto, there has been a question-and-answer system using information extraction for extracting specific information (for example, refer to JP-A-2002-132811). Such a question-and-answer system is a system in which when a document set and a question sentence are given, an answer to the question sentence is outputted. According to such a system, a search word set and a question type are discriminated from the inputted question sentence, a related document set is searched from the given document set in accordance with the search word set and the question type, and the answer is extracted from each document of the related document set and outputted. The information extraction is used in a portion for extracting the answer from the searched document set.

In the information extraction in the conventional question-and-answer system, nothing is shown in particular in the case where the document set which is inputted to the system is a document described in a hypertext format. However, in the document described in the hypertext format, there is a case where a document which is inherently supposed to be one document is divided into a plurality of documents and they are mutually linked in order to improve the easiness in reading. In such a case, it is insufficient if information is merely extracted only from the searched document. It is, therefore, necessary to extract information also from the document on the link destination side of the searched document.

Particularly, the number of documents described in the hypertext format has remarkably been increased due to the development of the Internet in recent years. If those documents cannot be processed accurately, it becomes a serious problem in not only the question-and-answers system but also various systems using the information extraction.

### SUMMARY OF THE INVENTION

It is an object of the invention to provide an information extracting apparatus which can properly extract information even from a document described in a hypertext format.

To accomplish the above object, the invention uses the following constructions.

According to the present invention, there is provided an information extracting apparatus for extracting designated information from a document group having a hypertext structure in which documents are mutually related by link information, comprising:

a start point address designating unit which designates an address of the document serving as a start point where the information is extracted; and

an extracting unit which extracts the information from the target document designated by the start point designating unit and, if the information could not be extracted from the target document, extracts the information from a related document of the target document on the basis of the address of the document.

Further, the information extracting apparatus may comprise a category designating unit which designates a category of the information to be extracted; and

an extracting unit which extracts the information corresponding to the category from the target document designated by the start point address designating unit and, if the information corresponding to the category could not be extracted from the target document, extracts the information from the related document of the target document on the basis of the address of the document.

Moreover, the information extracting apparatus may comprise a category layer specifying unit in which the category of the information to be extracted is expressed by a layer structure;

an extracting unit which, in the case where only an extraction result of a lower layer in the layer structure exists and an extraction result of an upper layer is missing as a result of the extraction of the information corresponding to the category from the target document designated by the start point address designating unit, extracts a character string of a layer which is higher than that of the extraction result of the lower layer from the related document of the target document; and

a processing unit which outputs a character string, as an extraction result, obtained by synthesizing the extraction result of the lower layer and the extraction result of the upper layer.

Furthermore, the information extracting apparatus may comprise an extracting unit which, in the case where the extraction result is separated into a plurality of character strings of the extraction result of the lower layer and the extraction result of the upper layer in the layer structure as a result of the extraction of the information corresponding to the category from the target document designated by the start point address designating unit, outputs the plurality of character strings as an extraction result of the lower layer and an extraction result of the upper layer.

Also, according to the present invention, there is provided another information extracting apparatus for extracting designated information from a document group having a hypertext structure in which documents are mutually related by link information, comprising:

an extracting unit which extracts target information from the document group and, in the case where addition or updating of a document occurs for the document group, executes an extracting process to which such addition or updating is reflected each time the addition or updating occurs, and outputs an extraction result including the target information and its document address;

an extraction result storing unit which stores the extraction result from the extracting unit as extraction result information;

a start point address designating unit which designates an address of a document serving as a start point where the designated information is extracted; and

a searching unit which extracts information from the document of the document address designated by the start point address designating unit and its related document with reference to the extraction result information in the extraction result storing unit.

Further, the information extracting apparatus may comprise a category designating unit which designates a category of the information to be extracted; and

a searching unit which extracts the information belonging to the category designated by the category designating unit.

Moreover, the information extracting apparatus may comprise a category layer specifying unit in which the category of the information to be extracted is expressed by a layer structure; and

a searching unit which, in the case where an extraction result of an upper layer is missing only in an extraction result of a lower layer in the layer structure as a result of the extraction of the information corresponding to the category from the target document designated by the start point address designating unit, extracts a character string of a layer which is higher than that of the extraction result of the lower layer from the related document of the target document, and outputs a character string, as an extraction result, obtained by synthesizing the extraction result of the lower layer and the extraction result of the upper layer.

Further, in the information extracting apparatuse, the related document includes at least one of a link destination document, a link source document, and an upper document of the target document. In this case, the upper document may be at least either a document of a specific name existing in a one-upper directory of the target document or a link source document existing in the one-upper directory.

Moreover, the information extracting apparatus may comprise a maximum link depth designating unit which designates a maximum link depth; and

an extracting unit which, in the case where the information could not be extracted from the target document, recursively executes a process for extracting the information from the related document of the document in a range of the designated maximum link depth.

Furthermore, the information extracting apparatus may comprise a maximum link depth designating unit which designates a maximum link depth; and

a searching unit which, in the case where the information could not be extracted from the target document, recursively executes a process for extracting the information from the related document of the document in a range of the designated maximum link depth.

Further, the information extracting apparatus may comprise an extracting unit which executes the information extracting process in order of the document in which a value of the link depth is small.

Moreover, the information extracting apparatus may comprise a searching unit which executes the information extracting process in order of the document in which a value of the link depth is small.

Furthermore, the information extracting apparatus may comprise an extracting unit which discriminates an internal link and an external link on the basis of the document address of the related document and excludes the documents of the external link from the targets of the information extraction.

Further, the information extracting apparatus may comprise a searching unit which discriminates an internal link and an external link on the basis of the document address of the related document and excludes the documents of the external link from the targets of the information extraction.

Moreover, the information extracting apparatus may comprise a processing unit which forms the character string of the processing result by coupling a plurality of character strings in order from the extraction result of the upper layer to the extraction result of the lower layer on the basis of the layer structure.

Furthermore, the information extracting apparatus may comprise a searching unit which forms a character string of a processing result by coupling a plurality of character strings in order from the extraction result of the upper layer to the extraction result of the lower layer on the basis of the layer structure.

Further, the information extracting apparatus may comprise a processing unit which has a predetermined synthesizing rule in the case of synthesizing a plurality of character strings expressed by the layer structure and forms a character string of a processing result in accordance with the synthesizing rule.

Moreover, the information extracting apparatus may comprise a searching unit which has a predetermined synthesizing rule in the case of synthesizing a plurality of character strings expressed by the layer structure and forms a character string of a processing result in accordance with the synthesizing rule.

The above and other objects and features of the present invention will become apparent from the following detailed description and the appended claims with reference to the accompanying drawings.

### BRIEF DESCRIPTION OF THE DRAWINGS

FIG. 1 is a constructional diagram showing the embodiment 1 of an information extracting apparatus according to the invention;

FIG. 2 is an explanatory diagram showing an example of documents which are stored into a storing unit;

FIG. 3 is a flowchart showing the operation of the embodiment 1;

FIG. 4 is an explanatory diagram (part 1) of data in a link information managing unit;

FIG. 5 is an explanatory diagram (part 2) of data in the link information managing unit;

FIG. 6 is an explanatory diagram (part 3) of data in the link information managing unit;

FIG. 7 is a constructional diagram showing the embodiment 2;

FIG. 8 is an explanatory diagram of a referring relation among documents 211 to 216;

FIGS. 9A to 9C are explanatory diagrams showing contents of the documents 211 to 216;

FIG. 10 is an explanatory diagram of a directory structure;

FIG. 11 is an explanatory diagram showing an example of data in a category layer specifying unit;

FIG. 12 is a flowchart showing the operation of the embodiment 2;

FIG. 13 is a constructional diagram showing the embodiment 3;

FIG. 14 is an explanatory diagram of data in an extraction result storing unit in the embodiment 3;

FIG. 15 is an explanatory diagram of a target document list;

FIG. 16 is a flowchart showing the operation at the time of registration in the embodiment 3;

FIG. 17 is a flowchart showing the operation at the time of searching in the embodiment 3;

FIG. 18 is a constructional diagram of the embodiment 4;

FIG. 19 is an explanatory diagram of data in an extraction result storing unit in the embodiment 4;

FIG. 20 is a flowchart showing the operation at the time of registration in the embodiment 4; and

FIG. 21 is a flowchart showing the operation at the time of searching in the embodiment 4.

### DETAILED DESCRIPTION OF THE PREFERRED EMBODIMENTS

Embodiments of the invention will be described in detail hereinbelow.

<<Embodiment 1>>

<Construction>

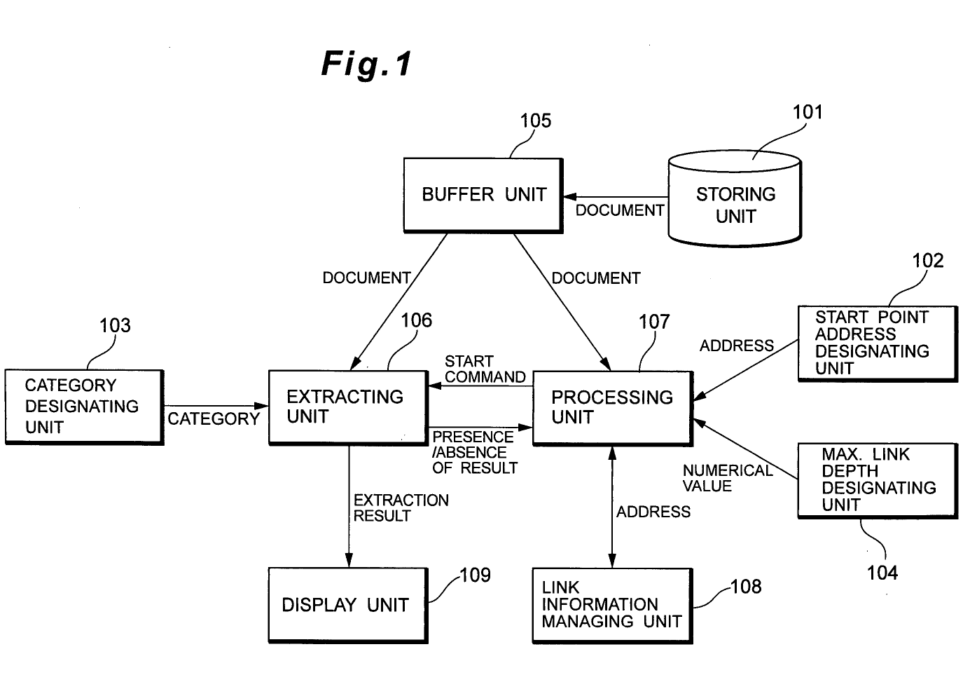

FIG. 1 is a constructional diagram showing the embodiment 1 of an information extracting apparatus according to the invention. The apparatus shown in the diagram is constructed by a computer and comprises: a storing unit 101; a start point address designating unit 102; a category designating unit 103; a maximum link depth designating unit 104; a buffer unit 105; an extracting unit 106; a processing unit 107; a link information managing unit 108; and a display unit 109. The storing unit 101 comprises, for example, a storing device such as a hard disk drive or the like and is a functional unit which stores documents as processing targets.

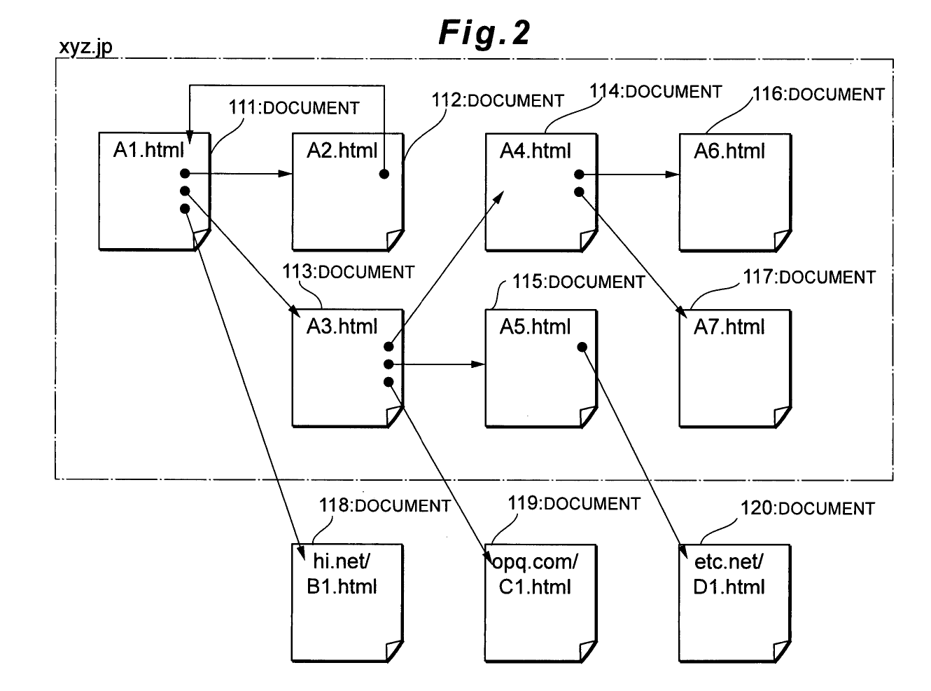

FIG. 2 is a diagram showing an example of the documents which are stored into the storing unit 101.

Although 20 documents 111 to 120 are shown in the example in the diagram, actually, a more number of other documents can exist. An arrow in the diagram indicates a link and shows that the document on the source side of the arrow has a link to the document on the destination side of the arrow. The documents 111 to 117 are the documents in the same site “xyz.jp”. In the diagram, addresses of those documents are written while omitting their site names. For example, although the document address of the document 111 is generally “xyz.jp/Al.html”, its site name is omitted and it is written only by “Al.html”. The documents 118 to 120 are the documents in sites other than the site “xyz.jp”.

Returning to FIG. 1, the start point address designating unit 102 is a functional unit which allows the user to designate the address of the target document to which the information extraction is executed. The category designating unit 103 is a functional unit which allows the user to designate a kind (category) of information which the user wants to extract. The maximum link depth designating unit 104 is a functional unit which allows the user to designate a range where the information extraction is executed. As such a range, for example, when a link depth is equal to 2, a range from the address of the start point document to the document to which the link is referred twice and at which it can arrive becomes a range where the information extraction is executed. The foregoing section of the start point address designating unit 102 to the maximum link depth designating unit 104 is constructed by, for example, input devices such as keyboard, pointing device, and the like.

The buffer unit 105 is a functional unit which obtains one target document from the storing unit 101 and temporarily stores it in order to allow the extracting unit 106 to extract the information or allow the processing unit 107 to execute the process. For example, the buffer unit 105 is realized by one area on a main memory.

The extracting unit 106 is a functional unit which extracts the information designated by the category designating unit 103 from the document stored in the buffer unit 105. The processing unit 107 is a functional unit constructed in a manner such that the extracting unit 106 is instructed to start the extraction, a flow of processes is controlled on the basis of the presence or absence of an extraction result of the extracting unit 106, link information is obtained from the buffer unit 105, in the case where the link information indicates a link to an internal site, the link information is recorded into the link information managing unit 108, and the document to be processed next is taken out from the storing unit 101 and loaded into the buffer unit 105 on the basis of the link information in the link information managing unit 108.

The link information managing unit 108 is a functional unit which manages a relation between the address of the link source side document and the address of the link destination side document by a tree structure starting with the start point address. The display unit 109 comprises a display apparatus such as a display or the like and its control unit and is a functional unit which displays the result extracted by the extracting unit 106.

The section of the extracting unit 106 to the link information managing unit 108 is realized by software corresponding to a construction of each of them and hardware such as CPU for executing those software, memory, and the like.

<Operation>

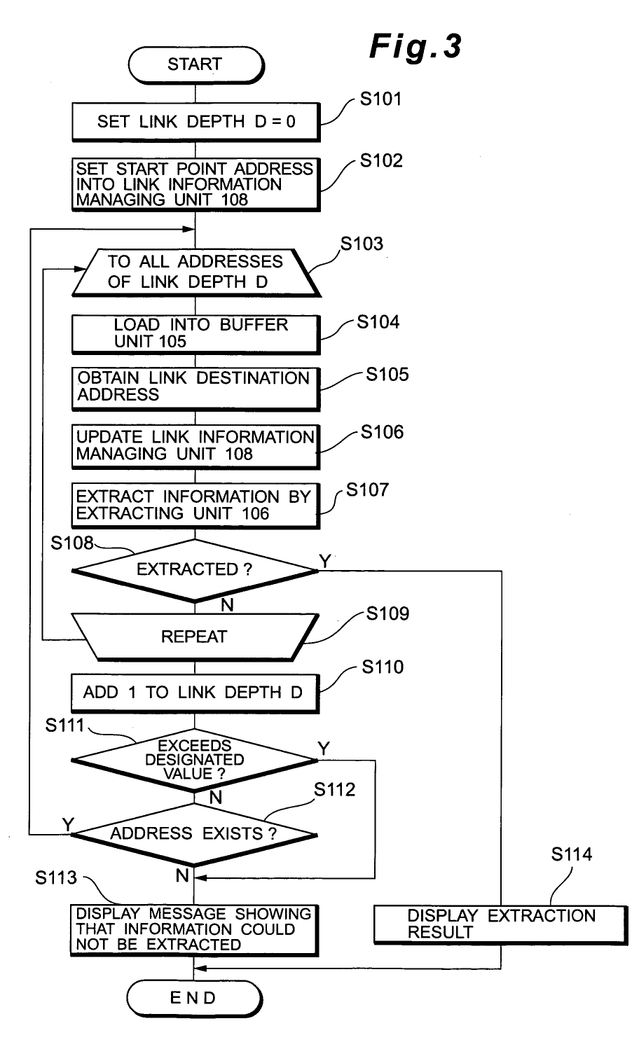

FIG. 3 is a flowchart showing the operation of the embodiment 1.

The operation will be described hereinbelow with reference to the flowchart.

First, 0 is substituted into a link depth D as a variable showing a current link depth (step S101). Subsequently, the address designated by the start point address designating unit 102 is set to the head of the link information managing unit 108 (step S102). For example, if “xyz.jp/Al.html” is designated as a start point address by the start point address designating unit 102, the data in the link information managing unit 108 is as follows.

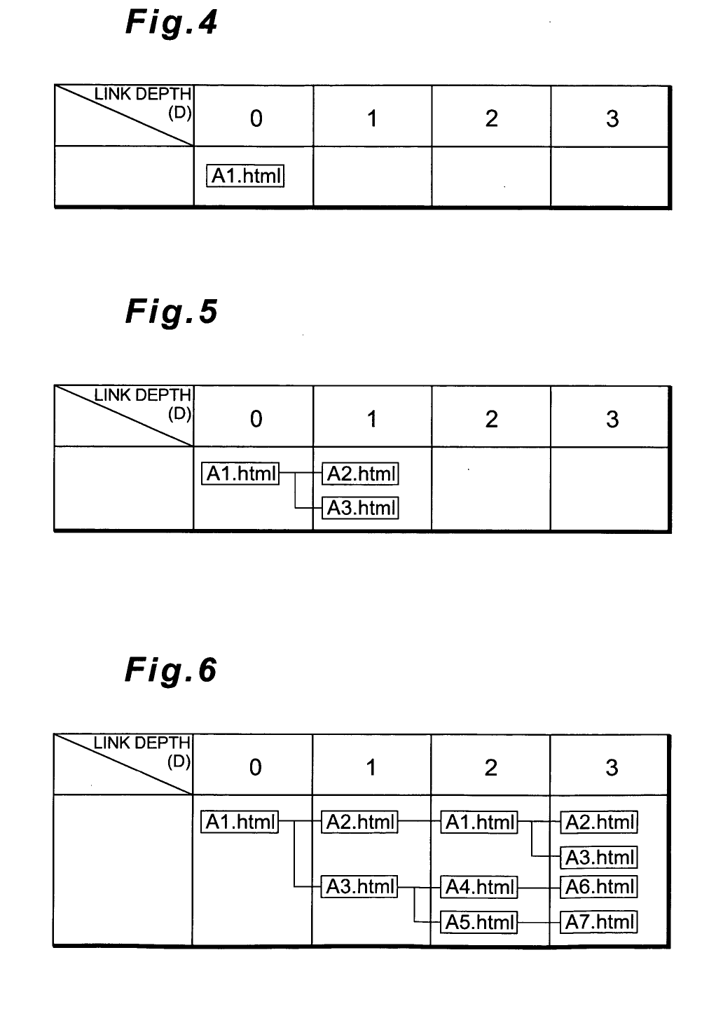

FIG. 4 is an explanatory diagram (part 1) of the data in the link information managing unit 108.

Since the link information managing unit 108 handles only the link in the site, the address is displayed while omitting the site name portion. Subsequently, processes in steps S104 to S108 are repetitively executed to all addresses of the link depth D with reference to the data in the link information managing unit 108 (step S103). Contents of the processes which are repeated are as follows.

First, the processing unit 107 discriminates whether there is a link in the document loaded into the buffer unit 105 or not and obtains all link destination addresses in the document (step S105). Only the link to the internal site is set as a lower address of the address which is being processed at present in the link information managing unit 108 (step S106). For example, if the link relation among the documents is as shown in FIG. 2, at a point of time when step S106 is finished for the first time, the data in the link information managing unit 108 is as follows.

FIG. 5 is an explanatory diagram (part 2) of the data in the link information managing unit 108.

Since the document 118 is a link to an external site, it is not set into the link information managing unit 108. Subsequently, the extracting unit 106 obtains information of the category designated by the category designating unit 103 from the documents in the buffer unit 105 and executes the information extraction (step S107). In step S107, if the extraction result was obtained (step S108), it is displayed by the display unit 109 (step S114) and the processing routine is finished.

If the extraction result is not obtained in step S108, the processing routine is returned to step S103 and the foregoing processes are repeated (step S109). After repetitive processing steps S103 to S109 are finished, the processing unit 107 adds 1 to a value of the link depth D (step S110). If a resultant value exceeds the value designated by the maximum link depth designating unit 104 (step S111) or although it does not exceeds the designated value in step S111, if the address to be processed next does not exist in the link information managing unit 108 (step S112), a message showing that the information could not be extracted is displayed (step S113) and the processing routine is finished. If the address to be processed next exists in step S112, the processing routine is returned to step S103 and the processes are repeated.

For example, in the case where the link relation among the documents is as shown in FIG. 2, when the link depth D which is designated by the maximum link depth designating unit 104 is equal to 2 and the information of the category designated by the category designating unit 103 could not be extracted to the end, the data in the link information managing unit 108 finally becomes as follows.

FIG. 6 is an explanatory diagram (part 3) of the data in the link information managing unit 108.

Since the documents 118 to 120 have the document addresses in the external site, respectively, they are not set into the link information managing unit 108. Since the referring relation among the links is looped, the addresses of the documents 118 to 120 appear twice as data in the link information managing unit 108, there is no problem on processes in particular.

<Effects>

As mentioned above, according to the embodiment 1, the following effects are obtained.

Since the information extraction is also performed from the link destination side, even if the document which is inherently supposed to be one document is divided into a plurality of documents and they are mutually linked in order to improve the easiness in reading, the information extraction can be executed accurately.

Since the invention has been constructed in a manner such that if the link destination is the external site, the information extraction is not executed, in the case of the link or the like which merely indicates for reference, the information is not provided from the link destination side but the information extraction can be executed accurately only from the document which is inherently supposed to be one document.

Since finishing conditions are set by the designation of the maximum link depth, even if the referring relation among the links constructs the loop, the apparatus operates without a problem.

Since the information extraction is executed in order of the document in which the value of the link depth is small, the documents can be processed in order of the document having a higher relationship and extracting precision and a processing speed can be improved. This is because, in general, there is a tendency such that the larger the value of the link depth is, the less the relationship between the target document and the related document becomes.

Since the previous process is unnecessary, a memory capacity to hold the processing result is not needed. Since the process is executed at a point of time when there is a request, it is possible to cope with the latest contents of the document.

<<Embodiment 2>>

According to the embodiment 2, in the case where the target document has been managed by a directory structure, the document of a specific name existing in the one-upper directory of the target document is set to an upper document and the upper document is also used as a target document of the information extraction.

<Construction>

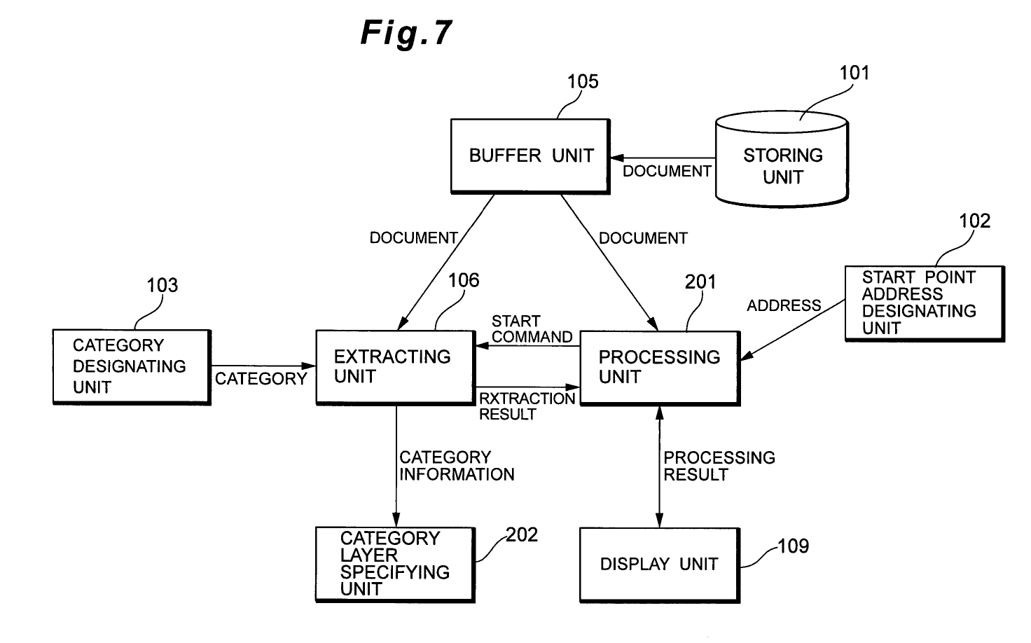

FIG. 7 is a constructional diagram of the embodiment 2.

An apparatus shown in the diagram comprises: the storing unit 101; the start point address designating unit 102; the category designating unit 103; the buffer unit 105; the extracting unit 106; the display unit 109; a processing unit 201; and a category layer specifying unit 202. Since a construction other than the processing unit 201 and the category layer specifying unit 202 is similar to that in the embodiment 1, the corresponding portions are designated by the same reference numerals and their description is omitted here.

The processing unit 201 is a functional unit which repeats processes such that the extracting unit 106 is instructed to start the extraction, when the extraction result of the extracting unit 106 is only a part of the category layer, an address of the upper document is formed from the address of the target document and information of the upper layer is extracted from the upper document and, finally, synthesizes those extraction results on the basis of the information of the layer structure of the category layer specifying unit 202 and outputs a synthesized result to the display unit 109. The category layer specifying unit 202 is a functional unit which specifies a vertical relationship of the data which is referred to by the extracting unit 106 and is the extraction result categories by the layer structure.

The processing unit 201 is realized by: software corresponding to each construction; and hardware such as CPU, memory, and the like for executing the software.

<Operation>

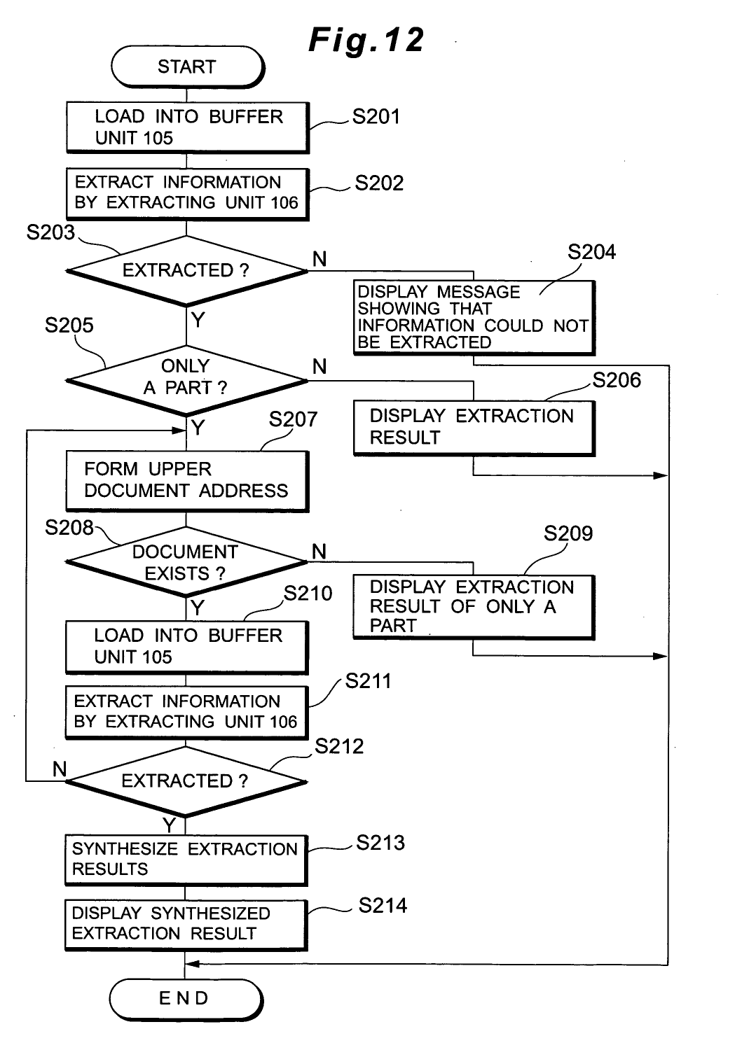

FIG. 12 is a flowchart showing the operation of the embodiment 2.

The operation will be described hereinbelow with reference to the flowchart.

First, contents of the document shown by the start point address designating unit 102 are loaded into the buffer unit 105 by the processing unit 201 (step S201). Subsequently, the extracting unit 106 extracts the information of the category designated by the category designating unit 103 from the document in the buffer unit 105 (step S202). If it could not be extracted by the extracting process (step S203), a message showing such a fact is displayed and the processing routine is finished. If the extraction result is perfect (in the case where it is not only a part), the extraction result is displayed (step S204) and the processing routine is finished (step S205, step S206). If the extraction result is only a part in step S205, the processing unit 201 forms an address of the upper document from the address of the processed document (step S207) and discriminates whether the document exists or not (step S208).

If the document does not exist in step S208, the extraction result of only a part is displayed (step S209) and the processing routine is finished. If the document exists, the contents in the document shown by the address are loaded into the buffer unit 105 (step S210). The information of the category designated by the category designating unit 103 from the document stored in the buffer unit 105 and of the layer higher than that of the information extracted in step S202 is extracted (step S211). If the information cannot be extracted by the extracting process in step S211 (step S212), the processing unit 201 returns to step S207 and forms an address of the document which is further higher than the document. As mentioned above, if the information cannot be extracted in step S212, the processes in steps S207 to S212 are recursively repeated. If the information could be extracted in step S212, it is synthesized with the previous extraction result (step S213), a synthesis result is displayed (step S214), and the processing routine is finished.

The operation will be described further in detail hereinbelow with respect to an example.

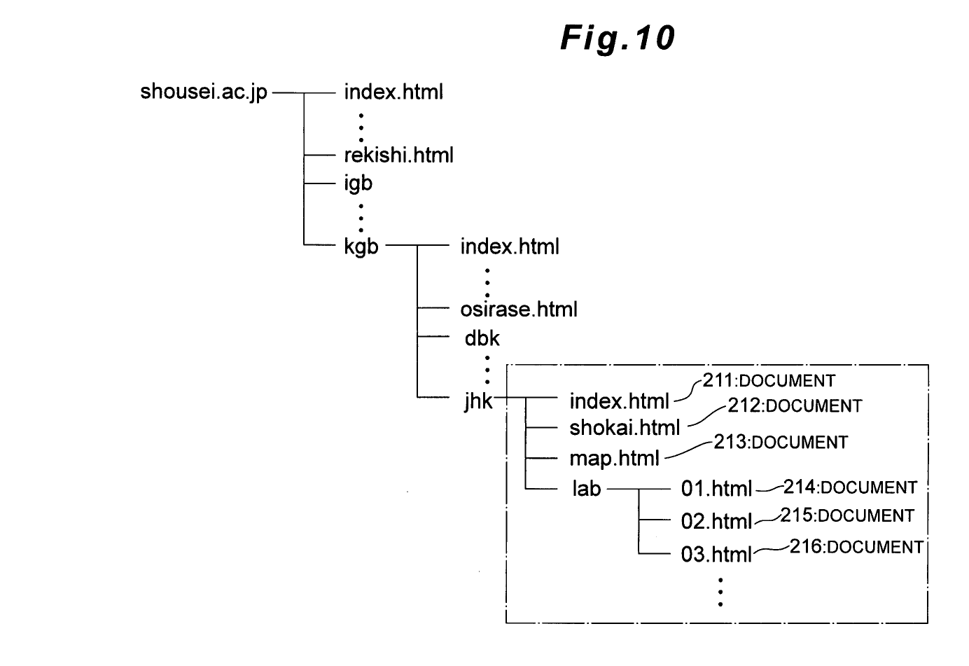

FIG. 10 is an explanatory diagram of a directory structure.

As shown in the diagram, it is assumed that many documents including documents 211 to 216 are managed. A referring relation among the documents shown in an alternate long and short dash line in FIG. 10 is as follows.

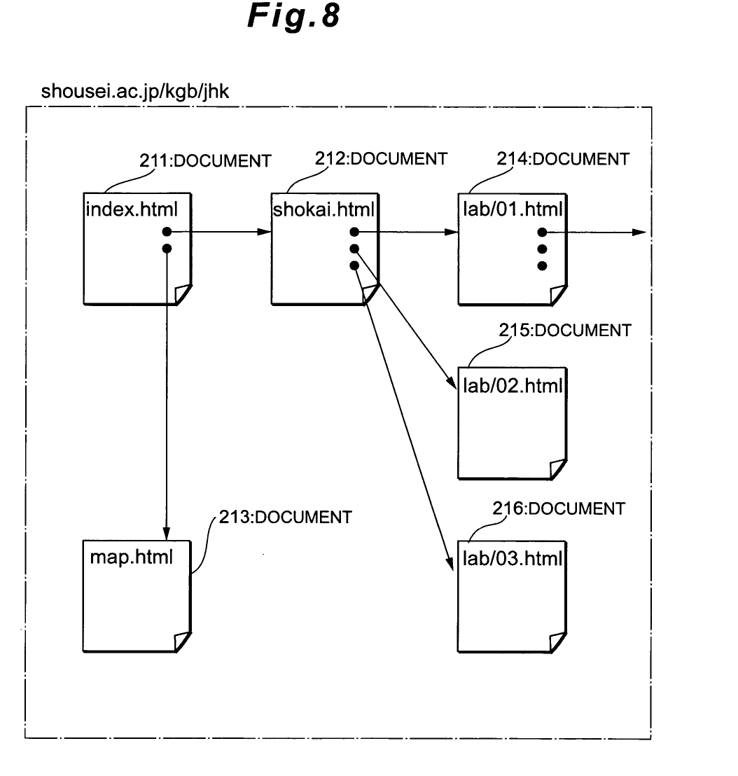

FIG. 8 is an explanatory diagram of the referring relation among the documents 211 to 216.

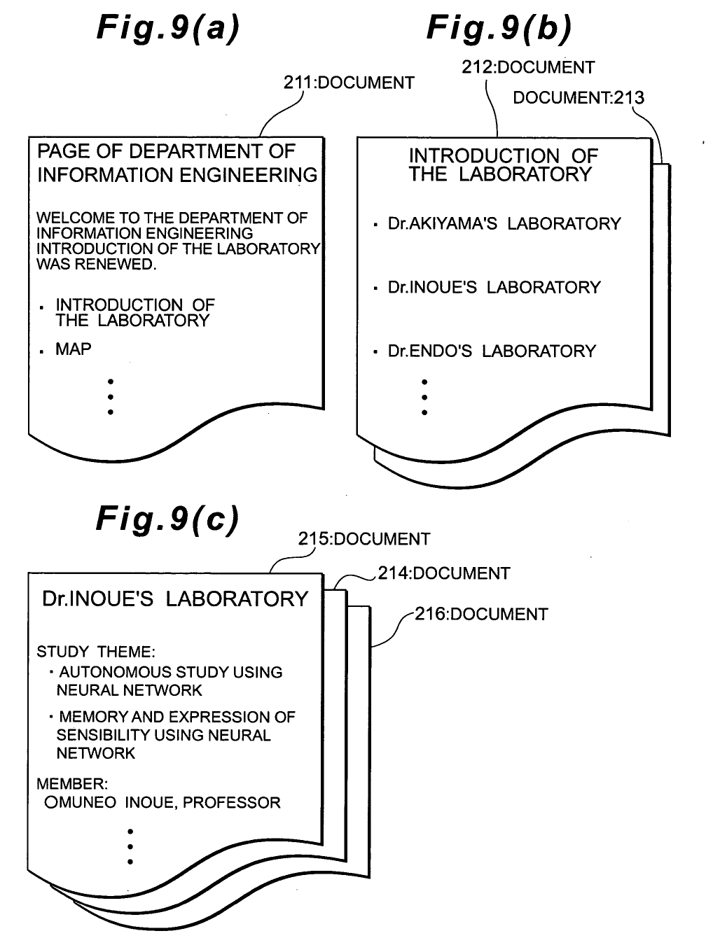

FIGS. 9A to 9C are explanatory diagrams showing contents of the documents 211 to 216.

Although other contents are omitted in FIG. 8 for the purpose of avoiding troublesomeness, actually, a name of the directory and the like are also included in the document address. For example, if the address of the document 211 is fully shown without omission, it is as follows.

“shousei.ac.jp/kgb/jhk/index.html”

To such a document, first, the processing unit 201 loads the contents in the document shown by the start point address designating unit 102 into the buffer unit 105 (step S201). Now, assuming that the start point address designating unit 102 indicates

“shousei.ac.jp/kgb/jhk/lab/02.html”,

the extracting unit 106 loads the contents as shown in FIG. 9C into the buffer unit 105.

Subsequently, the extracting unit 106 extracts the information of the category designated by the category designating unit 103 from the document in the buffer unit 105 (step S202). Now, assuming that “organization name” is designated as a category, the extracting unit 106 extracts a word “Dr. Inoue's laboratory” as an organization name as “laboratory name” from the contents in FIG. 9C. Such a process is executed by a method of extracting a character string including “laboratory” such as “ . . . laboratory” as a suffix. Subsequently, the processing unit 201 compares the extraction result with the layer of the organization name category of the category layer specifying unit 202 (steps S203, S205).

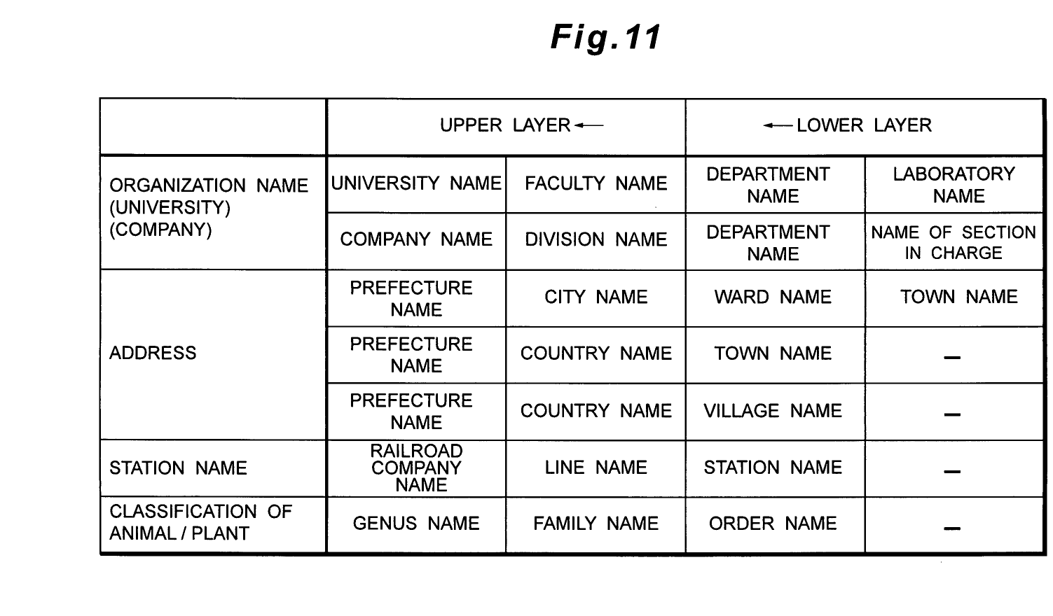

FIG. 11 is an explanatory diagram showing an example of data in the category layer specifying unit 202.

Referring to FIG. 11, it will be understood that in order to complete “organization name”, it is necessary to provide four information of “university name”, “faculty name”, “department name”, and “laboratory name” or four information of “company name”, “division name”, “department name”, and “name of section in charge”. Therefore, since only “laboratory name” could be extracted in this case, the extraction result is only a part. Accordingly, the processing unit 201 forms the address of the upper document from the original document address (step S207). It is assumed here that the upper document is a document of a name “index.html” of one-upper directory. Therefore, since the original document address is

“shousei.ac.jp/kgb/jhk/lab/02.html”,

the address of the upper document is

“shousei.ac.jp/kgb/jhk/index.html”.

Therefore, whether such an address exists or not is discriminated. Since such a document exists as a document 211, it is extracted as an upper document.

Therefore, the processing unit 201 loads contents as shown in FIG. 9A into the buffer unit 105 (step S210) and extracts “organization name” of the layer higher than that of “laboratory name” from this document (step S211). Assuming that “department of information engineering” could be consequently extracted as “department name”, “Dr. Inoue's laboratory” (laboratory name) as an extraction result in step S202 and “department of information engineering” (department name) extracted at present are combined in order shown by the category layer specifying unit 202. A word “department of information engineering, Dr. Inoue's laboratory” is synthesized (step S213) and displayed (step S214). The processing routine is finished.

<Effects>

According to the embodiment 2 as mentioned above, the following effects are obtained.

Since the information extraction is also performed from the upper document, even if the document which is inherently supposed to be one document is divided into a plurality of documents and they are mutually linked in order to improve the easiness in reading, the information extraction can be executed accurately.

Since only the information of the directory structure is used without using the information of the link, the information extraction can be realized by simple processes. Since the directory has the tree structure and a situation such that the loop is constructed like a link is avoided, the processes for eliminating them are unnecessary.

Since the words extracted from two documents are synthesized, the word which does not exist in the document can be outputted as a result. Further, since they are synthesized on the basis of the category layer, the synthesization of the words can be executed accurately.

Since the previous process is unnecessary, a memory capacity to hold the processing result is not needed. It is also possible to cope with the latest contents of the document.

<<Embodiment 3>>

The embodiment 3 is constructed so as to execute the information extraction and the obtainment of the link information at the time of collection of the documents in order to obtain a result similar to that in the embodiment 1.

<Construction>

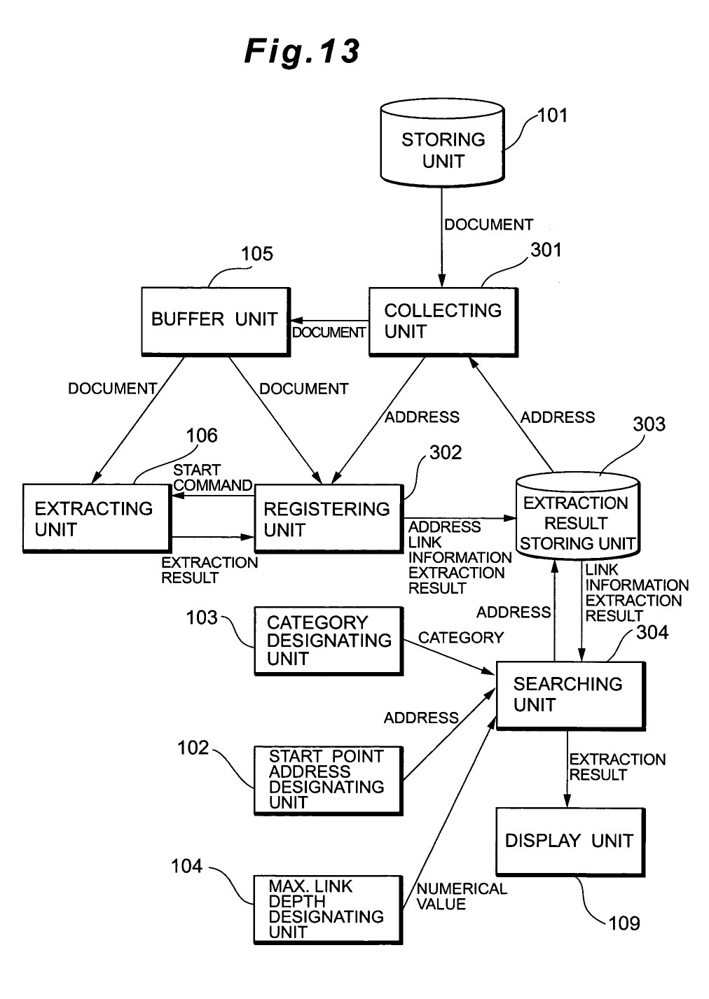

FIG. 13 is a constructional diagram of the embodiment 3.

An apparatus shown in the diagram comprises: the storing unit 101; the start point address designating unit 102; the category designating unit 103; the maximum link depth designating unit 104; the buffer unit 105; the extracting unit 106; the display unit 109; a collecting unit 301; a registering unit 302; an extraction result storing unit 303; and a searching unit 304. Since a construction of the storing unit 101 to the display unit 109 is similar to those in the embodiments 1 and 2, their description is omitted here.

The collecting unit 301 is a functional unit constructed in a manner such that in the case where a document has newly been registered into the storing unit 101 or the document has been changed, it is detected and registered into the registering unit 302. If the storing unit 101 is the World Wide Web (WWW: various documents which can be referred to via the Internet), an apparatus similar to a document collecting apparatus generally called a Web robot can be also used.

The registering unit 302 is a functional unit constructed in a manner such that the result of the information extracted by the extracting unit 106 from the document newly collected by the collecting unit 301 and the information of the link destination side or the link source side are registered into the extraction result storing unit 303. For example, in the case where the documents related by the link as shown in FIG. 2 have been registered, the data in the extraction result storing unit 303 becomes as follows.

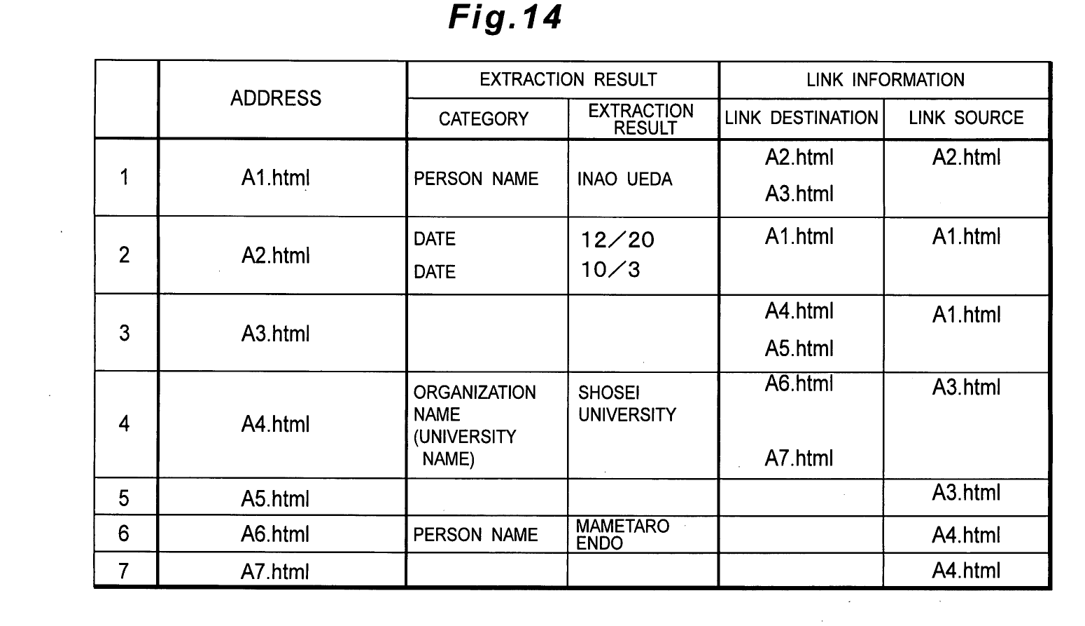

FIG. 14 is an explanatory diagram of the data in the extraction result storing unit 303.

In FIG. 14, since contents in each document are not shown, the extraction result is temporarily shown.

The searching unit 304 is a functional unit which searches for necessary information from the extraction result storing unit 303 and outputs its result to the display unit 109 on the basis of the conditions set by the start point address designating unit 102, category designating unit 103, and maximum link depth designating unit 104.

The collecting unit 301, the registering unit 302, and the searching unit 304 are realized by: software corresponding to each construction; and hardware such as CPU, memory, and the like for executing those software.

<Operation>

As an operation of the embodiment 3, the operation upon registering and the operation upon searching will be described in order.

FIG. 16 is a flowchart showing the operation at the time of registration in the embodiment 3.

When the collecting unit 301 finds out the document as a processing target, first, the target document is loaded into the buffer unit 105 (step S301). Subsequently, the extracting unit 106 executes the information extraction (step S302). At this time, the extraction is executed with respect to all categories irrespective of the contents in the category designating unit 103. Further, the registering unit 302 obtains the information of the link destination side and the link source side (step S303) and stores it into the extraction result storing unit 303 together with the result of the information extraction obtained in step S302 (step S304). The processing routine is finished. The processing result is shown in FIG. 14. The above operation is executed each time the collecting unit 301 finds out the document as a processing target.

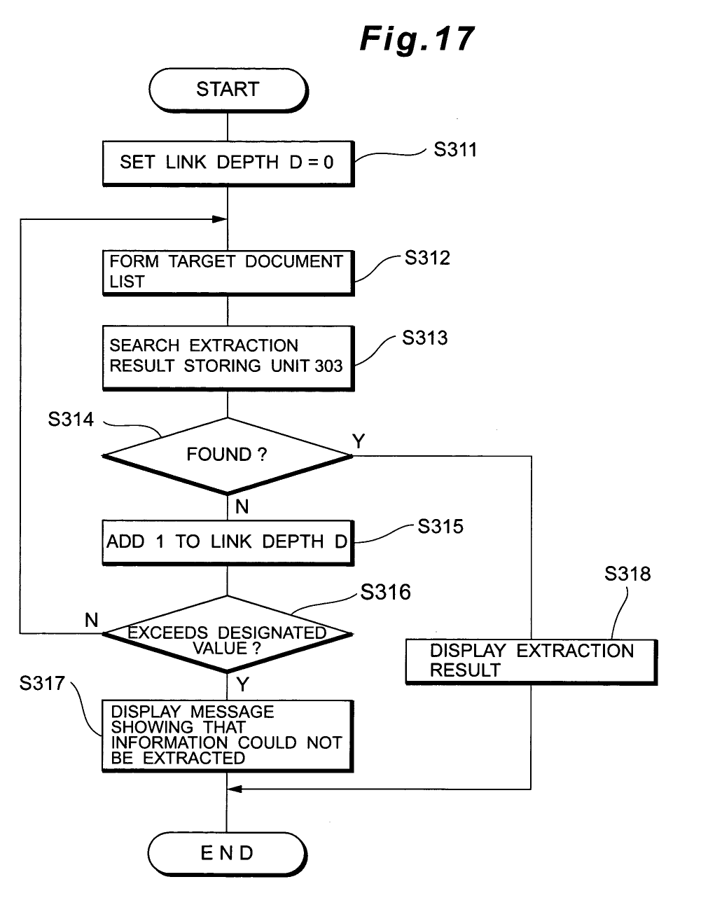

FIG. 17 is a flowchart showing the operation at the time of searching in the embodiment 3.

First, in the searching unit 304, 0 is substituted into the link depth D as a variable showing the current link depth (step S311). Subsequently, a target document list is formed on the basis of a value of the link depth D (step S312). The target document list is a list of documents in which the link destination side or the link source side can be traced from the start point address designating unit 102 the number of times of the link depth D. For example, when the link relation among the documents is as shown in FIG. 2, if “xyz.jp/A3.html” is designated as a start point address by the start point address designating unit 102, the target document list of each link depth D becomes as follows.

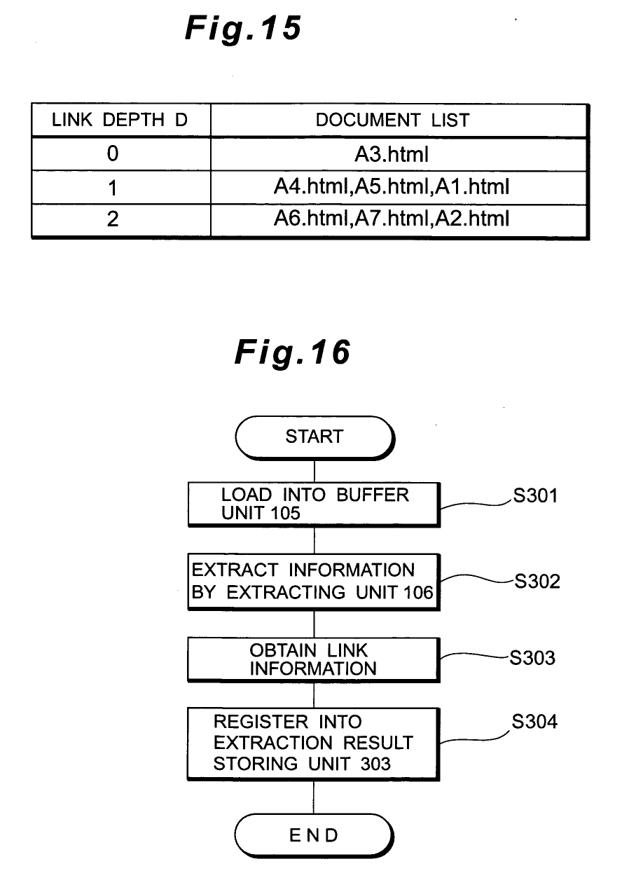

FIG. 15 is an explanatory diagram of the target document list.

Also in the embodiment 3, in a manner similar to the embodiment 1, it is assumed that the link to the external site is not used as a target.

Subsequently, with reference to the extraction result storing unit 303, the searching unit 304 discriminates whether the extraction result of the category designated by the category designating unit 103 exists in the target document or not (step S313). If it exists, the result is displayed (step S318) and the processing routine is finished. If it does not exist, 1 is added to the value of the link depth D (step S315). If an addition result exceeds the value shown by the maximum link depth designating unit 104, a message showing that the information could not be extracted is displayed (step S317) and the processing routine is finished. If it does not exceed the value, the processing routine is returned to step S312 and the processes are repeated.

<Effects>

As mentioned above, according to the embodiment 3, the following effects are obtained.

Since the information extraction is also performed from the link destination side, even if the document which is inherently supposed to be one document is divided into a plurality of documents and they are mutually linked in order to improve the easiness in reading, the information extraction can be executed accurately.

Since it is constructed in a manner such that if the link destination is the external site, the information extraction is not performed, in the case of a link such that which merely indicates for reference or the like, the information is not extracted from the link destination but the information can be extracted accurately only from the document which is inherently supposed to be one document.

Since end conditions are set by the designation of the maximum link depth, even if the referring relation among the links constructs the loop, the apparatus operates without any problem.

Since the information extraction is executed in order of the document in which the value of the link depth is small, the documents can be processed from the document whose relationship is higher and extracting precision and a processing speed can be improved.

Since the document addresses on the link destination side are previously collected, after the preceding process of all documents is finished, the information of the document addresses on the link source side can be perfectly collected. Therefore, the information extraction result from the document on the reference source side can be also used.

Since the preceding information extracting process has been completed, a response speed is high.

<<Embodiment 4>>

According to the embodiment 4, the information extraction and the obtainment of the link information and the address of the upper document are executed at the time of document collection in order to obtain a result similar to that in the embodiment 2. Further, as for the upper document, besides the document of the specific name existing in the one-upper directory described in the embodiment 2, if the document on the link source side exists in the one-upper directory, such a document is used as an upper document.

<Construction>

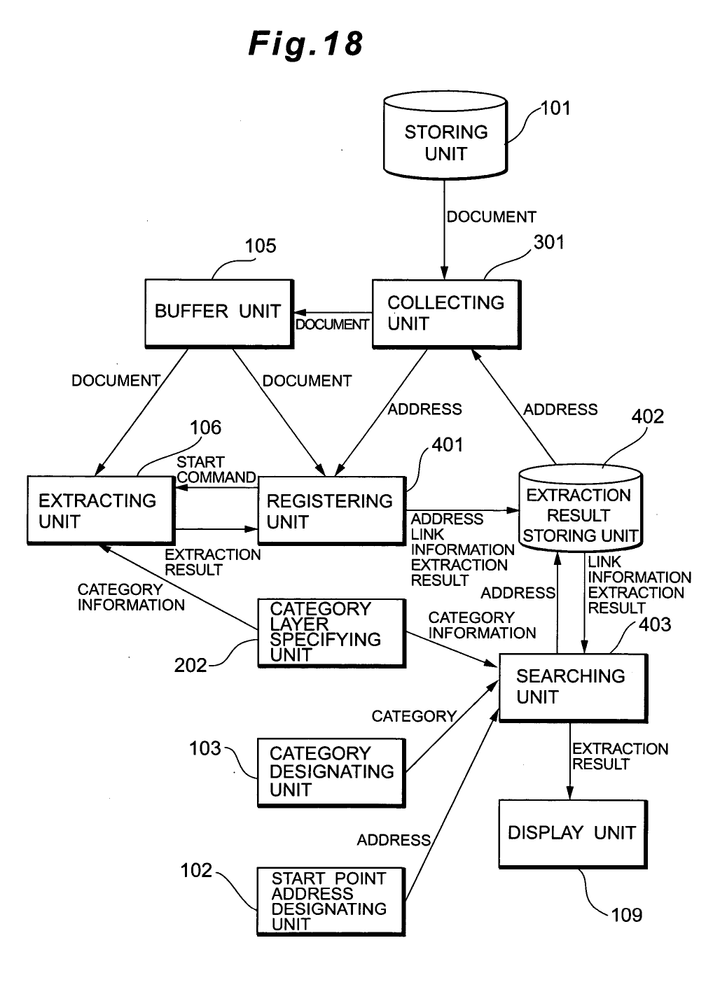

FIG. 18 is a constructional diagram of the embodiment 4.

An apparatus shown in the diagram comprises: the storing unit 101; the start point address designating unit 102; the category designating unit 103; the buffer unit 105; the extracting unit 106; the display unit 109; the category layer specifying unit 202; the collecting unit 301; a registering unit 401; an extraction result storing unit 402; and a searching unit 403. Since a construction of the storing unit 101 to the display unit 109 is similar to that in the embodiment 1, a construction of the category layer specifying unit 202 is similar to that of the embodiment 2, and a construction of the collecting unit 301 is similar to that of the embodiment 3, their description is omitted here.

The registering unit 401 is a functional unit constructed in a manner such that the result of the information extracted by the extracting unit 106 from the document newly collected by the collecting unit 301, the information of the link destination side or the link source side obtained from the contents of the document, and the document address of the upper document which was formed are stored into the extraction result storing unit 402. The extraction result storing unit 402 is a functional unit which manages the extraction result of each document, the information of the document address of the link destination side or the link source side, and the document address of the upper document. For example, in the case where the documents related by the link as shown in FIG. 8 have been registered, data in the extraction result storing unit 402 is as follows.

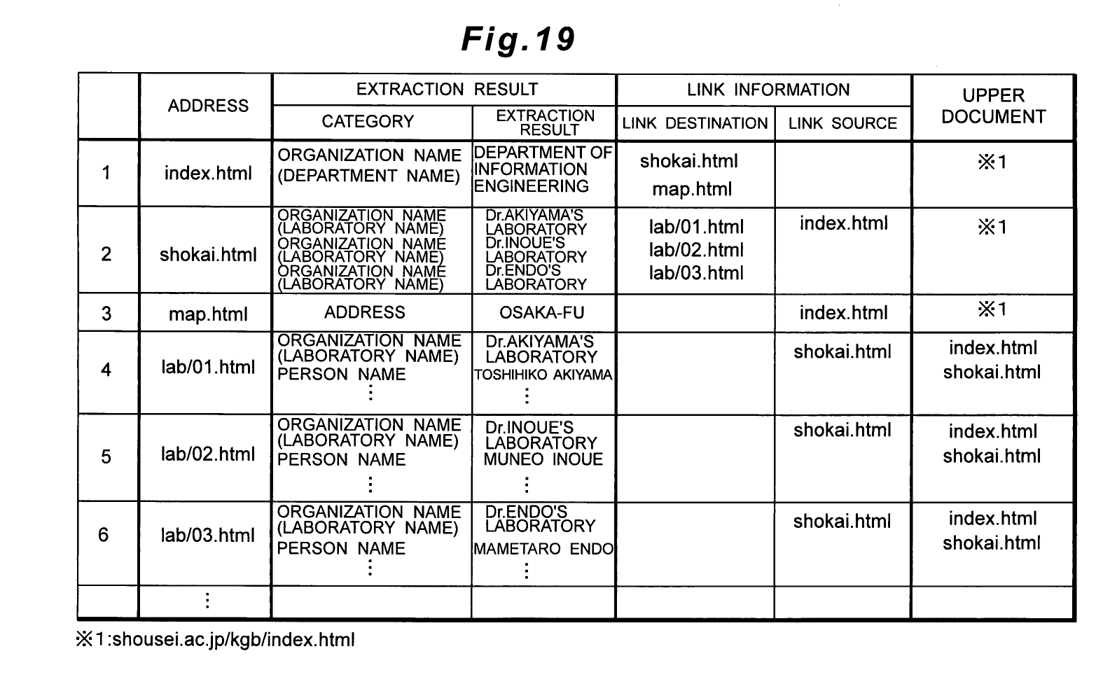

FIG. 19 is an explanatory diagram of the data in the extraction result storing unit 402.

Also in the embodiment 4, the name of the upper directory of the document address and the like are omitted in a manner similar to FIG. 8.

The searching unit 403 is a functional unit which searches for necessary information from the extraction result storing unit 402 on the basis of the conditions set by the start point address designating unit 102 and the category designating unit 103, synthesizes the word of the extraction result obtained as a result of the search on the basis of the layer specified by the category layer specifying unit 202, and outputs its result to the display unit 109 if necessary.

The registering unit 401 and the searching unit 403 are realized by: software corresponding to each construction; and hardware such as CPU, memory, and the like for executing those software.

<Operation>

As an operation of the embodiment 4, the operation upon registering and the operation upon searching will be described in order.

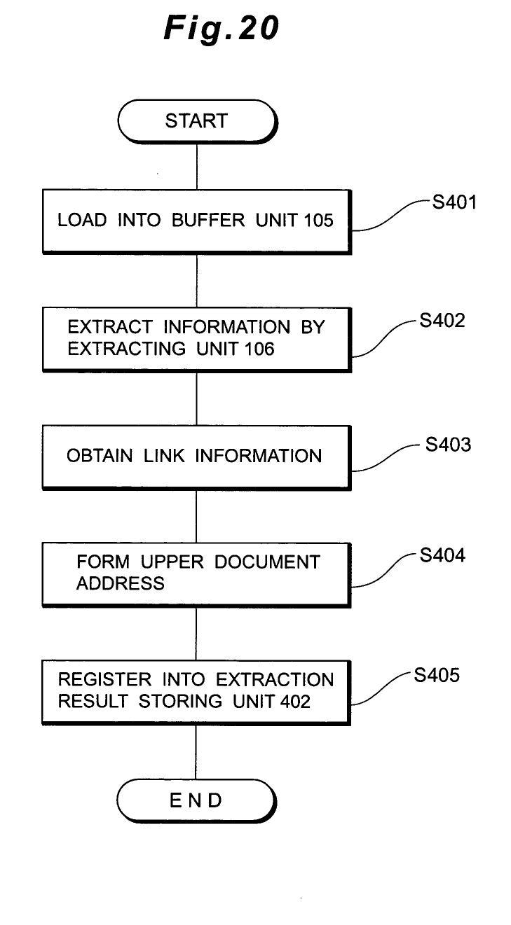

FIG. 20 is a flowchart showing the operation at the time of registration in the embodiment 4.

When the collecting unit 301 finds out the document as a processing target, first, the target document is loaded into the buffer unit 105 (step S401). Subsequently, the extracting unit 106 executes the information extraction (step S402). At this time, the extraction is executed with respect to all categories irrespective of the contents in the category designating unit 103. Subsequently, the registering unit 401 obtains the information of the link destination side and the link source side (step S403) and, further, forms an upper document address (step S404). As for the upper document, besides the document of the specific name existing in the one-upper directory described in the embodiment 2, if the document on the link source side exists in the one-upper directory, such a document is used as an upper document. That is, although the maximum number of upper documents is equal to 1 in the embodiment 2, there is a case where there are a plurality of upper documents in the embodiment 4.

Finally, the result of the information extraction obtained in step S402, the information of the link destination side and the link source side obtained in step S403, and the upper document address obtained in step S404 are stored into the extraction result storing unit 402 (step S405) and the processing routine is finished. FIG. 19 shows the data in the extraction result storing unit 402 after completion of the process. The above operation is executed each time the collecting unit 301 finds out the document as a processing target.

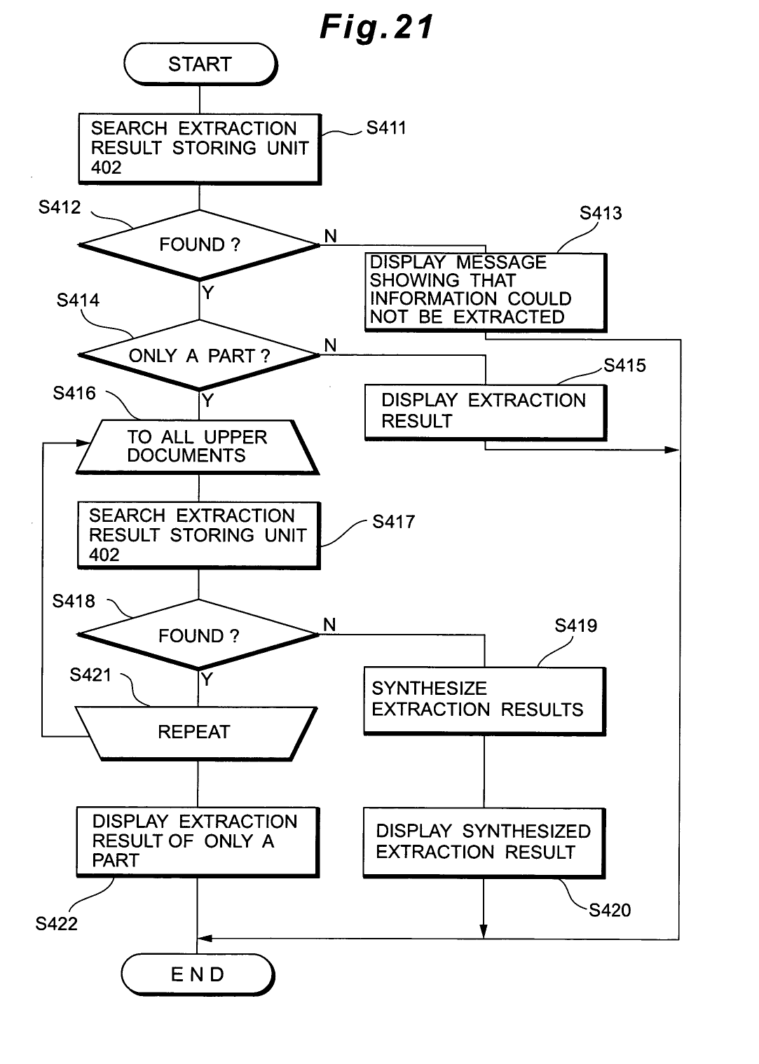

FIG. 21 is a flowchart showing the operation at the time of searching in the embodiment 4.

First, the searching unit 403 searches whether the extraction result of the category information designated by the category designating unit 103 exists in the extraction result storing unit 402 or not from the document shown by the start point address designating unit 102 (step S411). If it does not exist, a message showing that it could not be extracted is displayed by the display unit 109 (step S413) and the processing routine is finished. If the existing extraction result is perfect (in the case where it is not only a part), the extraction result is displayed and the processing routine is finished (step S415).

If the extraction result is only a part, whether the extraction result of the category designated by the category designating unit 103 and the layer which is higher than that obtained in step S411 exists in the extraction result storing unit 402 or not is searched (step S417) with respect to all upper document addresses registered in the relevant portion in the extraction result storing unit 402 (step S416). If such an extraction result exists in the search (step S418), it is synthesized with the extraction result obtained before (step S419), a synthesis result is displayed (step S420), and the processing routine is finished. If the extraction result does not exist in step S418, steps S417 and S418 are repeated (step S421). After completion of the repetition, the extraction result of only a part is displayed (step S422) and the processing routine is finished.

The operation at the time of searching will be described further in detail hereinbelow by using an example.

In this example, it is assumed that many documents including the documents 211 to 216 have been managed by the directory structure as shown in FIG. 10 in the storing unit 101. The referring relation among the documents shown in the alternate long and short dash line in FIG. 10 is as shown in FIG. 8. Although other contents are omitted in FIG. 8 for the purpose of avoiding troublesomeness, actually, a name of the directory and the like are also included in the document address. For example, if the address of the document 211 is fully shown without omission, it is as follows.

“shousei.ac.jp/kgb/jhk/index.html”

When the operation at the time of registration is executed, the contents in the extraction result storing unit 402 are as shown in FIG. 19.

Now, assuming that the start point address designating unit 102 indicates

“shousei.ac.jp/kgb/jhk/lab/02.html”

and the category designating unit 103 designates “organization name” as a category, the searching unit 403 obtains a result in which the word “Dr. Inoue's laboratory” as an organization name has been extracted as “laboratory name” with reference to the column of the extraction result on the fifth row in the extraction result storing unit 402 (step S411). It is compared with the layer of the “organization name” category of the category layer specifying unit 202 (step S414). The data in the category layer specifying unit 202 is as shown in FIG. 11.

Referring to FIG. 11, it will be understood that in order to complete “organization name”, it is necessary to provide four information of “university name”, “faculty name”, “department name”, and “laboratory name” or four information of “company name”, “division name”, “department name”, and “name of section in charge”. Therefore, since only “laboratory name” could be extracted, the extraction result is only a part and the processing routine advances to step S416. Subsequently, the searching unit 403 knows that the upper documents are

“shousei.ac.jp/kgb/jhk/shokai.html” and

“shousei.ac.jp/kgb/jhk/index.html”

by referring to the column of the upper documents on the fifth row in the extraction result storing unit 402. The searching unit 403 executes the searching process to them (step S416).

First, when

“shousei.ac.jp/kgb/jhk/shokai.html”

is used as a target, a result in which three words of “Dr. Akiyama's laboratory”, “Dr. Inoue's laboratory”, and “Dr. Endo's laboratory” as organization names have been extracted as “laboratory name” can be obtained by referring to the second row in the extraction result storing unit 402. However, since their layers are not higher than those of “laboratory name” obtained in step S411, it is determined that the necessary words could not be obtained. The processing routine advances to step S421 and next

“shousei.ac.jp/kgb/jhk/index.html”

is processed as a target. Similarly, a result in which a word “department of information engineering” as an organization name has been extracted as “department name” can be obtained by referring to the first row in the extraction result storing unit 402. Since it is known that it corresponds to the upper layer of “laboratory name” obtained in step S411 by referring to the category layer specifying unit 202, it is decided that the target word existed.

The processing routine advances to step S419.

“Dr. Inoue's laboratory” (laboratory name) obtained in step S411 and “department of information engineering” (department name) obtained in step S417 are combined in order shown by the category layer specifying unit 202, a word “department of information engineering, Dr. Inoue's laboratory” is synthesized (step S419), and it is displayed (step S420). The processing routine is finished.

<Effects>

As mentioned above, according to the embodiment 4, the following effects are obtained.

Since the information extraction is also performed from the upper document, even if the document which is inherently supposed to be one document is divided into a plurality of documents and they are mutually linked in order to improve the easiness in reading, the information extraction can be executed accurately.

Since the information of the directory structure and the information of the reference source side of the link are combined and used, a situation such that the loop is constructed as in the case of only the link information does not occur. Therefore, a process for eliminating them is unnecessary.

Since the words extracted from two documents are synthesized, the word which does not exist in the document can be outputted as a result. Further, since they are synthesized on the basis of the category layer, the synthesization of the words can be executed accurately.

Since the document addresses on the link destination side are previously collected, after the preceding process of all documents is finished, the information of the document addresses on the link source side can be perfectly collected. Therefore, the information extraction result from the document on the reference source side can be also used.

Since the preceding information extracting process has been completed, a response speed is high.

<<Application Forms>>

To assist the understanding in the embodiments 3 and 4, the item for storing the document address of the link source document has been provided as data in the extraction result storing units 303 and 402 and described. However, this item is not essential. So long as an item for storing the address of the link destination document exists in the extraction result storing unit 303 (402), the address of the link source document can be easily searched from the item on the contrary.

In the embodiment 4, to assist the understanding, the item for storing the upper document has been provided as a data structure in the extraction result storing unit 402 and described. However, this item is not always necessary. It can be also formed as necessary in a manner similar to the embodiment 2.

In the embodiment 2, the explanation has been made on the assumption that the extracting process is finished if the information of the upper layer can be extracted from the upper document. That is, the explanation has been made on the assumption that the maximum number of words to be synthesized is equal to 2. However, it is also possible to construct in a manner such that even after the information of the upper layer could be extracted, by further continuing to extract the information of the upper layer from the upper document of the target document, all words which could be extracted are synthesized. In other words, there is also a case of synthesizing three or more words.

In the embodiment 4, to simplify the explanation, a point that the process to set the upper document to the target document is recursively repeated was not described. However, it can be also recursively repeated in a manner similar to the processes in steps S207 to S212 in the embodiment 2. Even after the information of the upper layer could be obtained as mentioned above, it is also possible to repetitively obtain the information and synthesize three or more words.

In the embodiment 4, although the explanation has been made on the assumption that the upper documents are set to both of the document of the specific name existing in the one-upper directory of the target document and the document of the link source side of the target document, that is, the document existing in the one-upper directory, only either of them can be also used as an upper document.

In the embodiments 1 to 4, the storing unit 101 can be set to any form so long as it is an existing location of a document such as document on the network such as WWW (World Wide Web), document stored in a storing apparatus such as a hard disk apparatus, or the like.

In the embodiment 1, although the explanation has been made on the assumption that the information is extracted from the document on the link destination side, the invention is not limited to it. As another method, the upper document described in the embodiment 2 or 4 can be used as a target or both of the document on the link destination side and the upper document can be also used as targets.

In the embodiment 3, although the explanation has been made on the assumption that the information extraction results are obtained from both of the document on the link destination side and the document on the link source side, the upper document described in the embodiment 2 or 4 can be also added as targets. Further, a selected one of the three kinds of documents of the document on the link destination side, the document on the link source side, and the upper document or a combination of two or more of them can be also used as targets.

In the embodiments 2 and 4, although the explanation has been made on the assumption that the word extracted from the start point document and the word extracted from the upper document are synthesized, the invention is not limited to it. The words extracted from the same document can be synthesized or the words extracted from the document on the link destination side and the document on the link source side can be also synthesized.

In the embodiments 2 and 4, although the explanation has been made on the assumption that the words are combined in order disclosed in the category layer specifying unit 202 in the case of synthesizing the extraction results, the order of coupling the extracted words can be also additionally defined as a synthesizing rule. As a synthesizing rule, any rule can be used so long as it specifies the coupling order. For example, there are the following synthesizing rules.

For example, it is assumed that district names as information could be extracted as follows.

<Prefecture name>=Osaka-fu

<City name>=Osaka-shi

<Ward name>=Naniwa-ku

<Town name>=Nihonbashi

If there are the following two rules,

Rule A:

<Prefecture name>+<City name>+<Ward name>+<Town name>

Rule B:

<Town name>+“(“+<Prefecture name>+”)”

the following results are obtained.

Processing Result of the Rule A:

Osaka-fu Osaka-shi Naniwa-ku Nihonbashi

Processing Result of the Rule B:

Nihonbashi (Osaka-fu)

If the user wants to express the accurate address, the rule A is effective. If the user wants to specify the town name and express it simply, the rule B is effective.

In the embodiments 2 and 4, although “index.html” which is generally used as an upper document has been used as an upper document, the invention is not limited to it. Any document can be used so long as the document of the specific name is predetermined.

In the embodiments 1 to 4, although the display unit 109 is a functional unit which displays by a displaying apparatus such as a display or the like, for example, a functional unit which performs a print output by a printing apparatus can be also used.

Two, three, or four of the embodiments 1 to 4 can be also arbitrarily combined.

As mentioned above, according to the invention, in the case of extracting the designated information from the document group having the hypertext structure, if the information could not be extracted from the document of a certain start point address, the information is extracted from the related document of such a document. Therefore, even in the case where a document which is inherently supposed to be one document is divided into a plurality of documents and they are mutually linked, the information extraction can be executed accurately.

The present invention is not limited to the foregoing embodiments but many modifications and variations are possible within the spirit and scope of the appended claims of the invention.

What is claimed is:

1. An information extracting apparatus for extracting designated information from a document group having a hypertext structure in which documents are mutually related by link information, comprising:
a start point address designating unit which designates an address of the document serving as a start point where said information is extracted; and
an extracting unit which extracts said information from the target document designated by said start point designating unit and, if said information could not be extracted from said target document, extracts said information from a related document of said target document on the basis of the address of said document.

2. The apparatus according to claim 1, further comprising:
an extracting unit which discriminates an internal link and an external link on the basis of the document address of the related document and excludes the documents of the external link from the targets of the information extraction.

3. The apparatus according to claim 1, further comprising:
a maximum link depth designating unit which designates a maximum link depth; and
an extracting unit which, in the case where the information could not be extracted from the target document, recursively executes a process for extracting the information from the related document of said document in a range of said designated maximum link depth.

4. The apparatus according to claim 3, further comprising:
an extracting unit which discriminates an internal link and an external link on the basis of the document address of the related document and excludes the documents of the external link from the targets of the information extraction.

5. The apparatus according to claim 3, further comprising:
an extracting unit which executes the information extracting process in order of the document in which a value of the link depth is small.

6. The apparatus according to claim 5, further comprising:
an extracting unit which discriminates an internal link and an external link on the basis of the document address of the related document and excludes the documents of the external link from the targets of the information extraction.

7. The apparatus according to claim 1, wherein said related document includes at least one of a link destination document, a link source document, and an upper document of the target document.

8. The apparatus according to claim 7, wherein said upper document is at least either a document of a specific name existing in a one-upper directory of the target document or a link source document existing in the one-upper directory.

9. The apparatus according to claim 1, further comprising:
a category designating unit which designates a category of the information to be extracted; and
an extracting unit which extracts the information corresponding to said category from the target document designated by said start point address designating unit and, if the information corresponding to said category could not be extracted from said target document, extracts said information from the related document of said target document on the basis of the address of said document.

10. The apparatus according to claim 9, further comprising:
an extracting unit which discriminates an internal link and an external link on the basis of the document address of the related document and excludes the documents of the external link from the targets of the information extraction.

11. The apparatus according to claim 9, further comprising:
a maximum link depth designating unit which designates a maximum link depth; and
an extracting unit which, in the case where the information could not be extracted from the target document, recursively executes a process for extracting the information from the related document of said document in a range of said designated maximum link depth.

12. The apparatus according to claim 11, further comprising:
an extracting unit which discriminates an internal link and an external link on the basis of the document address of the related document and excludes the documents of the external link from the targets of the information extraction.

13. The apparatus according to claim 11, further comprising:
an extracting unit which executes the information extracting process in order of the document in which a value of the link depth is small.

14. The apparatus according to claim 13, further comprising:
an extracting unit which discriminates an internal link and an external link on the basis of the document address of the related document and excludes the documents of the external link from the targets of the information extraction.

15. The apparatus according to claim 9, wherein said related document includes at least one of a link destination document, a link source document, and an upper document of the target document.

16. The apparatus according to claim 15, wherein said upper document is at least either a document of a specific name existing in a one-upper directory of the target document or a link source document existing in the one-upper directory.

17. The apparatus according to claim 9, further comprising:
a category layer specifying unit in which the category of the information to be extracted is expressed by a layer structure;
an extracting unit which, in the case where only an extraction result of a lower layer in said layer structure exists and an extraction result of an upper layer is missing as a result of the extraction of the information corresponding to the category from the target document designated by said start point address designating unit, extracts a character string of a layer which is higher than that of the extraction result of said lower layer from the related document of said target document; and
a processing unit which outputs a character string, as an extraction result, obtained by synthesizing the extraction result of said lower layer and the extraction result of said upper layer.

18. The apparatus according to claim 17, further comprising:
a processing unit which has a predetermined synthesizing rule in the case of synthesizing a plurality of character strings expressed by the layer structure and forms a character string of a processing result in accordance with said synthesizing rule.

19. The apparatus according to claim 17, further comprising:
a processing unit which forms the character string of the processing result by coupling a plurality of character strings in order from the extraction result of the upper layer to the extraction result of the lower layer on the basis of the layer structure.

20. The apparatus according to claim 19, further comprising:
a processing unit which has a predetermined synthesizing rule in the case of synthesizing a plurality of character strings expressed by the layer structure and forms a character string of a processing result in accordance with said synthesizing rule.

21. The apparatus according to claim 17, further comprising:
an extracting unit which discriminates an internal link and an external link on the basis of the document address of the related document and excludes the documents of the external link from the targets of the information extraction.

22. The apparatus according to claim 17, further comprising:
a maximum link depth designating unit which designates a maximum link depth; and
an extracting unit which, in the case where the information could not be extracted from the target document, recursively executes a process for extracting the information from the related document of said document in a range of said designated maximum link depth.

23. The apparatus according to claim 22, further comprising:
an extracting unit which discriminates an internal link and an external link on the basis of the document address of the related document and excludes the documents of the external link from the targets of the information extraction.

24. The apparatus according to claim 22, further comprising:
an extracting unit which executes the information extracting process in order of the document in which a value of the link depth is small.

25. The apparatus according to claim 24, further comprising:
an extracting unit which discriminates an internal link and an external link on the basis of the document address of the related document and excludes the documents of the external link from the targets of the information extraction.

26. The apparatus according to claim 17, wherein said related document includes at least one of a link destination document, a link source document, and an upper document of the target document.

27. The apparatus according to claim 26, wherein said upper document is at least either a document of a specific name existing in a one-upper directory of the target document or a link source document existing in the one-upper directory.

28. The apparatus according to claim 17, further comprising:
an extracting unit which, in the case where the extraction result is separated into a plurality of character strings of the extraction result of the lower layer and the extraction result of the upper layer in said layer structure as a result of the extraction of the information corresponding to the category from the target document designated by said start point address designating unit, outputs said plurality of character strings as an extraction result of the lower layer and an extraction result of the upper layer.

29. The apparatus according to claim 28, further comprising:
a processing unit which has a predetermined synthesizing rule in the case of synthesizing a plurality of character strings expressed by the layer structure and forms a character string of a processing result in accordance with said synthesizing rule.

30. The apparatus according to claim 28, further comprising:
a processing unit which forms the character string of the processing result by coupling a plurality of character strings in order from the extraction result of the upper layer to the extraction result of the lower layer on the basis of the layer structure.

31. The apparatus according to claim 30, further comprising:
a processing unit which has a predetermined synthesizing rule in the case of synthesizing a plurality of character strings expressed by the layer structure and forms a character string of a processing result in accordance with said synthesizing rule.

32. The apparatus according to claim 28, further comprising:
an extracting unit which discriminates an internal link and an external link on the basis of the document address of the related document and excludes the documents of the external link from the targets of the information extraction.

33. The apparatus according to claim 28, further comprising:
a maximum link depth designating unit which designates a maximum link depth; and
an extracting unit which, in the case where the information could not be extracted from the target document, recursively executes a process for extracting the information from the related document of said document in a range of said designated maximum link depth.

34. The apparatus according to claim 33, further comprising:
an extracting unit which discriminates an internal link and an external link on the basis of the document address of the related document and excludes the documents of the external link from the targets of the information extraction.

35. The apparatus according to claim 33, further comprising:
an extracting unit which executes the information extracting process in order of the document in which a value of the link depth is small.

36. The apparatus according to claim 35, further comprising:
an extracting unit which discriminates an internal link and an external link on the basis of the document address of the related document and excludes the documents of the external link from the targets of the information extraction.

37. The apparatus according to claim 28, wherein said related document includes at least one of a link destination document, a link source document, and an upper document of the target document.

38. The apparatus according to claim 37, wherein said upper document is at least either a document of a specific name existing in a one-upper directory of the target document or a link source document existing in the one-upper directory.

39. An information extracting apparatus for extracting designated information from a document group having a hypertext structure in which documents are mutually related by link information, comprising:
an extracting unit which extracts target information from said document group and, in the case where addition or updating of a document occurs for said document group, executes an extracting process to which such addition or updating is reflected each time said addition or updating occurs, and outputs an extraction result including said target information and its document address;
an extraction result storing unit which stores the extraction result from said extracting unit as extraction result information;
a start point address designating unit which designates an address of a document serving as a start point where said designated information is extracted; and
a searching unit which extracts information from the document of the document address designated by said start point address designating unit and its related document with reference to the extraction result information in said extraction result storing unit.

40. The apparatus according to claim 39, further comprising:
a searching unit which discriminates an internal link and an external link on the basis of the document address of the related document and excludes the documents of the external link from the targets of the information extraction.

41. The apparatus according to claim 39, further comprising:
a maximum link depth designating unit which designates a maximum link depth; and
a searching unit which, in the case where the information could not be extracted from the target document, recursively executes a process for extracting the information from the related document of said document in a range of said designated maximum link depth.

42. The apparatus according to claim 41, further comprising:
a searching unit which discriminates an internal link and an external link on the basis of the document address of the related document and excludes the documents of the external link from the targets of the information extraction.

43. The apparatus according to claim 41, further comprising:
a searching unit which executes the information extracting process in order of the document in which a value of the link depth is small.

44. The apparatus according to claim 43, further comprising:
a searching unit which discriminates an internal link and an external link on the basis of the document address of the related document and excludes the documents of the external link from the targets of the information extraction.

45. The apparatus according to claim 39, wherein said related document includes at least one of a link destination document, a link source document, and an upper document of the target document.

46. The apparatus according to claim 45, wherein said upper document is at least either a document of a specific name existing in a one-upper directory of the target document or a link source document existing in the one-upper directory.

47. The apparatus according to claim 39, further comprising:
a category designating unit which designates a category of the information to be extracted; and
a searching unit which extracts the information belonging to the category designated by said category designating unit.

48. The apparatus according to claim 47, further comprising:
a searching unit which discriminates an internal link and an external link on the basis of the document address of the related document and excludes the documents of the external link from the targets of the information extraction.

49. The apparatus according to claim 47, further comprising:
a maximum link depth designating unit which designates a maximum link depth; and
a searching unit which, in the case where the information could not be extracted from the target document, recursively executes a process for extracting the information from the related document of said document in a range of said designated maximum link depth.

50. The apparatus according to claim 49, further comprising:
a searching unit which discriminates an internal link and an external link on the basis of the document address of the related document and excludes the documents of the external link from the targets of the information extraction.

51. The apparatus according to claim 49, further comprising:
a searching unit which executes the information extracting process in order of the document in which a value of the link depth is small.

52. The apparatus according to claim 51, further comprising:
a searching unit which discriminates an internal link and an external link on the basis of the document address of the related document and excludes the documents of the external link from the targets of the information extraction.

53. The apparatus according to claim 47, wherein said related document includes at least one of a link destination document, a link source document, and an upper document of the target document.

54. The apparatus according to claim 53, wherein said upper document is at least either a document of a specific name existing in a one-upper directory of the target document or a link source document existing in the one-upper directory.

55. The apparatus according to claim 47, further comprising:
a category layer specifying unit in which the category of the information to be extracted is expressed by a layer structure; and
a searching unit which, in the case where an extraction result of an upper layer is missing only in an extraction result of a lower layer in said layer structure as a result of the extraction of the information corresponding to the category from the target document designated by said start point address designating unit, extracts a character string of a layer which is higher than that of the extraction result of said lower layer from the related document of said target document, and outputs a character string, as an extraction result, obtained by synthesizing the extraction result of said lower layer and the extraction result of said upper layer.

56. The apparatus according to claim 55, further comprising:
a searching unit which discriminates an internal link and an external link on the basis of the document address of the related document and excludes the documents of the external link from the targets of the information extraction.

57. The apparatus according to claim 55, further comprising:
a maximum link depth designating unit which designates a maximum link depth; and
a searching unit which, in the case where the information could not be extracted from the target document, recursively executes a process for extracting the information from the related document of said document in a range of said designated maximum link depth.

58. The apparatus according to claim 57, further comprising:
a searching unit which discriminates an internal link and an external link on the basis of the document address of the related document and excludes the documents of the external link from the targets of the information extraction.

59. The apparatus according to claim 57, further comprising:
a searching unit which executes the information extracting process in order of the document in which a value of the link depth is small.

60. The apparatus according to claim 59, further comprising:
a searching unit which discriminates an internal link and an external link on the basis of the document address of the related document and excludes the documents of the external link from the targets of the information extraction.

61. The apparatus according to claim 55, wherein said related document includes at least one of a link destination document, a link source document, and an upper document of the target document.

62. The apparatus according to claim 61, wherein said upper document is at least either a document of a specific name existing in a one-upper directory of the target document or a link source document existing in the one-upper directory.

63. The apparatus according to claim 55, further comprising:
a searching unit which has a predetermined synthesizing rule in the case of synthesizing a plurality of character strings expressed by the layer structure and forms a character string of a processing result in accordance with said synthesizing rule.

64. The apparatus according to claim 55, further comprising:
a searching unit which forms a character string of a processing result by coupling a plurality of character strings in order from the extraction result of the upper layer to the extraction result of the lower layer on the basis of the layer structure.

65. The apparatus according to claim 64, further comprising:
a searching unit which has a predetermined synthesizing rule in the case of synthesizing a plurality of character strings expressed by the layer structure and forms a character string of a processing result in accordance with said synthesizing rule.
